(19) United States
(12) Patent Application Publication
(10) Pub. No.: US 2003/0085093 A1
(43) Pub. Date: May 8, 2003

(54) Mounting/centering support arrangement

(75) Inventors: Markus Heiartz, Wurzburg (DE); Olaf Pagels, Bergrheinfeld (DE); Georg Zink, Gerolzhofen (DE); Sebastian Vogt, Bad Neustadt (DE); Andreas Orlamunder, Schweinfurt (DE); Ingrid Hoffelner, Knetzgau (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/266,108

(22) Filed: Oct. 7, 2002

(30) Foreign Application Priority Data
Oct. 9, 2001 (DE) 101 49 707.5
Aug. 9, 2002 (DE) 102 36 590.3

(51) Int. Cl. F16D 21/02

(52) U.S. Cl. 192/48.8; 192/89.24

(57) ABSTRACT

A mounting/centering support arrangement for a pressure plate assembly of a multi-clutch arrangement is provided. The pressure plate assembly comprises at least two clutch areas, each with a pressure plate arrangement connected to a housing arrangement for rotation in common around an axis of rotation; with an opposing support arrangement; and with a clutch disk arrangement, the friction surface arrangement of which can be clamped between the pressure plate arrangement and the opposing support arrangement. Each of the clutch disk arrangements is designed to be connected nonrotatably to a different power takeoff element. The mounting/centering support arrangement can arrest at least one of the clutch disk arrangements in a predefinable position with respect to the housing arrangement and/or arrest at least one of the clutch disk arrangements in a predefinable position with respect to at least one other clutch disk arrangement.

### BACKGROUND OF THE INVENTION

1. Field of the Invention

The present invention pertains to a mounting/centering support arrangement for a pressure plate assembly of a multi-clutch arrangement, which pressure plate assembly comprises at least two clutch areas, each with a pressure plate arrangement connected to a housing arrangement for rotation in common around an axis of rotation; with an opposing support arrangement; and with a clutch disk arrangement, the friction surface arrangement of which can be clamped between the pressure plate arrangement and the opposing support arrangement, where each of the clutch disk arrangements is designed to be connected nonrotatably to a different power takeoff element.

2. Description of the Related Art

When pressure plate assemblies of this type are attached to other system components of a drive train, an example being when the transmission input shafts, which are usually concentric to each other, are introduced and connected to the associated clutch disk arrangements of the various clutch areas, there is the basic problem that two or more clutch disk arrangements, which are in fact disconnected from each other in terms of motion in common, must each be connected to the element assigned to it, that is, to the assigned transmission input shaft. If these clutch disk arrangements are not in a defined position, it is difficult to introduce the associated transmission input shafts correctly into them. The problem is even more difficult when one or more of the clutch areas are of the normally open type. In this design, the clutch area is not pretensioned by a stored-energy device to remain in the engaged state; on the contrary, it must be brought actively into the engaged state by the production of an actuating force exerted by, for example, a clutch-engaging system. That is, in the absence of an actuating force, the associated clutch disk arrangement is not tightly clamped and thus not held in a defined position.

### SUMMARY OF THE INVENTION

The task of the present invention is to provide a mounting/centering support arrangement which makes it easier to attach a pressure plate assembly of a multi-clutch arrangement of this type to other system components, especially to the power takeoff elements, which are usually designed as transmission input shafts.

According to a first aspect of the present invention, each of the clutch disk arrangements is designed to be connected nonrotatably to a different power takeoff element, and where the mounting/centering support arrangement can arrest at least one of the clutch disk arrangements in a predefinable position with respect to the housing arrangement and/or arrest at least one of the clutch disk arrangements in a predefinable position with respect to at least one of the other clutch disk arrangements.

Because at least one of the clutch disks is held in a defined position with respect to the housing arrangement and/or because at least two of the clutch disks arrangements are held in a defined position with respect to each other, the number of degrees of freedom to be managed during the assembly process is significantly reduced.

It is possible, for example, to provide a centering element arrangement which works together with at least two clutch disk arrangements, preferably in or near the associated hub areas of these disk arrangements, to center the clutch disk arrangements with respect to each other.

To prevent in particular an interfering interaction between the components present in the pressure plate assembly, it is proposed that the centering element arrangement have a plurality of centering tongues, which contact the inside circumferential surface of the hub areas of the minimum of two clutch disk arrangements. To arrive at a defined positional correlation, it is possible for the centering tongues to rest under pretension against the inside circumferential surface of at least one of the hub areas.

In an alternative design, it is possible for the centering element arrangement to comprise at least one wedge-shaped slider element, which can be clamped between an inside circumferential surface of one of the hub areas and an outside circumferential surface of one of the other hub areas.

Because a wedge-shaped slider element cannot usually be removed from the pressure plate assembly after the centering function has been released, it is also proposed that the minimum of one wedge-shaped slider element have a fastening element, upon which a force can be exerted to release the clamping effect and which can be plastically deformed to hold the minimum of one wedge-shaped slider element on one of the clutch disk arrangements in a position in which it does not center the two clutch disk arrangements with respect to each other. In this way, the minimum of one wedge-shaped slider element is held in place in such a way that it can no longer exert a centering function on the two clutch disk arrangements with respect to each other.

According to an alternative embodiment, it is possible for the centering element arrangement to comprise at least one centering bolt, which can be shifted preferably in the direction parallel to the axis of rotation to release the centering function and which, when the centering function is being produced, engages at least in the clutch disk arrangements.

Because the radially outer area of a pressure plate assembly of this type is usually enclosed by a housing arrangement, it is very difficult to gain radial access to the various system components. It is therefore proposed that it be possible to release the centering function of the centering element arrangement by displacing the arrangement axially with respect to the clutch disk arrangements.

To make it even easier to attach a pressure plate assembly to the various power takeoff elements in particular, a rotational position-specifying arrangement can be provided, by means of which the relative rotational position of the clutch disk arrangements with respect to each other can be specified in cooperation with complementary rotational position-specifying arrangements on the clutch disk arrangements to be centered.

According to another alternative embodiment, two clutch disk arrangements can be centered with respect to each other by providing the centering element arrangement with at least one area for adhesive bonding, by means of which the clutch disk arrangements can be bonded firmly but detachably to each other in or near their hub areas. To ensure that the various clutch disk arrangements can rotate freely with respect to each other afterwards, i.e., in the assembled state, it is proposed that the adhesive bond be breakable by the application of a mechanical load, heat, or moisture.

Alternatively or in addition to the previously described measures, which have the main goal of connecting at least two clutch disk arrangements directly to each other, it can be provided that a centering element arrangement which cooperates with the associated pressure plate arrangement and/or with the opposing support arrangement and/or with the housing arrangement is provided for at least one of the clutch disk arrangements. When several of the clutch disk arrangements are thus held in a defined place with respect to one of the assemblies indicated, it is thus also possible in this way for the clutch disk arrangements to be held in a defined place with respect to each other.

Here, too, it is possible for the centering element arrangement to comprise at least one adhesive bonding area. It is again advantageous in this case for the adhesive bond to be breakable by the application of a mechanical load, heat, or moisture.

In an alternative, very easy-to-produce embodiment, the centering with respect to the housing arrangement, a pressure plate arrangement, or an opposing support arrangement can be achieved by providing the centering element arrangement with a plurality of centering projections on the friction surface arrangement of at least one of the clutch disk arrangements, which projections are designed to make centering contact with a centering area of the associated pressure plate arrangement, of the opposing support arrangement, or of the housing arrangement. To ensure here, too, that, after assembly, this retaining or centering function is released, it is proposed that at least a certain area of the minimum of one centering projection be removed by the rotation of the clutch disk arrangement carrying the projection with respect to the assembly provided with the centering area.

The previously described measures have the goal of predetermining a defined positional correlation between at least one clutch disk arrangement and other system components. Various assemblies are required to carry out this function, assemblies which must be removed or which must be brought into an inoperative state after the installation process is complete.

According to another aspect of the present invention, an aspect which makes it possible to avoid additional components for defining a positional correlation, a funnel-shaped insertion arrangement for the power takeoff element to be connected to this clutch disk arrangement is provided on a hub area of at least one of the clutch disk arrangements. By providing this type of insertion arrangement, it is possible to ensure that, when the various system areas are attached to each other, the elements to be connected are brought into their proper relative positions essentially independently of the positional correlation of a clutch disk arrangement with respect to, for example, the housing arrangement.

For this purpose, the minimum of one clutch disk arrangement is held with play in the radial direction with respect to the housing arrangement, and an insertion opening of the insertion arrangement is large enough that, when the insertion end of the associated power takeoff element approaches, this insertion opening overlaps the insertion end essentially completely, regardless of the radial position of the clutch disk arrangement with respect to the housing arrangement.

It is also possible for the hub area to comprise a toothing arrangement with a plurality of teeth which are arranged around the inside circumferential surface of the hub area, the lengthwise dimension of the teeth being parallel to the axis of rotation, to establish the connection with the power takeoff element for rotation in common, and for at least a part of the insertion arrangement to be provided on at least one of these teeth.

So that it is possible with an arrangement such as this not only to predetermine the defined positional correlation in the radial direction but also to assist the process of bringing the various elements into the proper relative rotational positions which allow them to be connected to each other, it is proposed that the hub area comprise a toothing arrangement for establishing the connection with the power takeoff for rotation in common, this toothing arrangement consisting of a plurality of teeth arranged around the inside circumferential surface of the hub area, the lengthwise dimension of the teeth being parallel to the axis of rotation, and that at least one of the teeth taper down in the circumferential direction toward the insertion opening.

In accordance with another aspect of the present invention, at least one of the clutch disk arrangements is held with some play in the radial direction with respect to the housing arrangement, and where an insertion opening in a hub area of the minimum of one clutch disk arrangement is large enough that, when the insertion end of the associated power takeoff element approaches, the insertion opening completely overlaps the insertion end, regardless of the radial position of the clutch disk arrangement with respect to the housing arrangement.

In addition, it is possible, for example, for the power takeoff element which is to be connected to the minimum of one clutch disk arrangement to have a taper at the insertion end.

According to another aspect of the present invention, at least one of the clutch areas is of the normally open type, which is in a released state in the absence of an actuating force and which can be brought into the engaged state under the action of such an actuating force. By the production of an actuating force for the sake of assembly, the minimum of one clutch area can be held in an engaged-for-the-sake-of-assembly state in which the clutch disk arrangement of the clutch area in question is clamped between its assigned pressure plate arrangement and the opposing support arrangement.

Because a normally open clutch area is held in the engaged state at least until the end of the assembly process and because, as a result, the clutch disk arrangement of the clutch area is held forcibly in place with respect to the housing arrangement, it is also possible to complete the assembly process more easily, because the position of at least this clutch disk arrangement is predetermined in a defined manner.

For this purpose, the mounting/centering support arrangement can include first mounting element, which can be connected to the opposing support arrangement for the performance of an assembly procedure, and a second mounting element, which can be shifted with respect to the first mounting element in the direction parallel to the axis of rotation to produce a for-the-sake-of-assembly actuating force for the minimum of one clutch area. The support against the opposing support arrangement therefore makes it possible for this for-the-sake-of-assembly actuating force to be produced for the minimum of one clutch area.

To obtain in particular the defined positional correlation with respect to the transmission to be connected to a pressure plate assembly of this type, this centering arrangement can also include a third mounting element, designed to be attached to a transmission shroud or the like, on which third element the first mounting element is carried in such a way that its rotational position can be adjusted.

The present invention also pertains to a pressure plate assembly for a multi-clutch arrangement, in which pressure plate assembly at least one of the preceding measures facilitating mounting or centering is provided.

The invention is described in detail below on the basis of preferred exemplary embodiments, which are illustrated in the attached drawings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal cross section through a dual clutch, i.e., through a pressure plate assembly of such a clutch;

FIG. 2 shows a detailed view of the pressure plate assembly illustrated in FIG. 1;

FIG. 3 shows a view, radially from the outside, of the pressure plate assembly of FIG. 1;

FIG. 4 shows a detailed view of the hub areas of the two clutch disk arrangements, which are centered with respect to each other by a centering element;

FIG. 5 shows the centering element of FIG. 4 as it is being pulled out;

FIG. 6 shows a pressure plate assembly for a dual clutch in conjunction with a centering element of an alternative design;

FIG. 7 shows another detailed view of the hub areas of the clutch disk arrangements, which are centered with respect to each other by a wedge-shaped slider element;

FIG. 8 shows the wedge-shaped slider of FIG. 7 in an inactive state;

FIG. 9 shows another detailed view of the hub areas of two clutch disk arrangements, where the hub areas are held with respect to each other by a centering bolt;

FIG. 10 shows another partial longitudinal cross section through a dual clutch, i.e., through a pressure plate assembly of such a clutch, where the centering of the clutch disk arrangements is achieved by adhesive bonding;

FIG. 11 shows a view similar to that of FIG. 10, in which an alternative type of centering is provided for the clutch disk arrangements with respect to the associated pressure plate arrangements;

FIG. 12 shows a partial axial view of a friction lining of the dual clutch shown in FIG. 11;

FIG. 13 shows a partial longitudinal cross section through a dual clutch, i.e., through the pressure plate assembly of such a clutch, in which funnel-shaped insertion openings are provided in the area of the hubs of the clutch disk arrangements;

FIG. 14 shows an enlarged, schematic, longitudinal cross section of a hub area, cut along line XIV-XIV in FIG. 15, which can be used in the pressure plate assembly of FIG. 13;

FIG. 15 shows the hub area of FIG. 14, viewed in the radial direction XV;

FIG. 16 shows a partial longitudinal cross section through the transmission input shafts to be connected to the various clutch disk arrangements;

FIG. 17 shows another embodiment of a mounting/centering support arrangement according to the invention;

FIG. 18 shows a detailed view of the arrangement of FIG. 17;

FIG. 19 shows another detailed view of the arrangement of FIG. 17;

FIG. 20 shows a perspective view of the arrangement shown in FIG. 17; and

FIG. 21 shows a schematic diagram of the mounting of a dual clutch in a transmission shroud.

### DETAILED DESCRIPTION OF THE PRESENTLY PREFERRED EMBODIMENTS

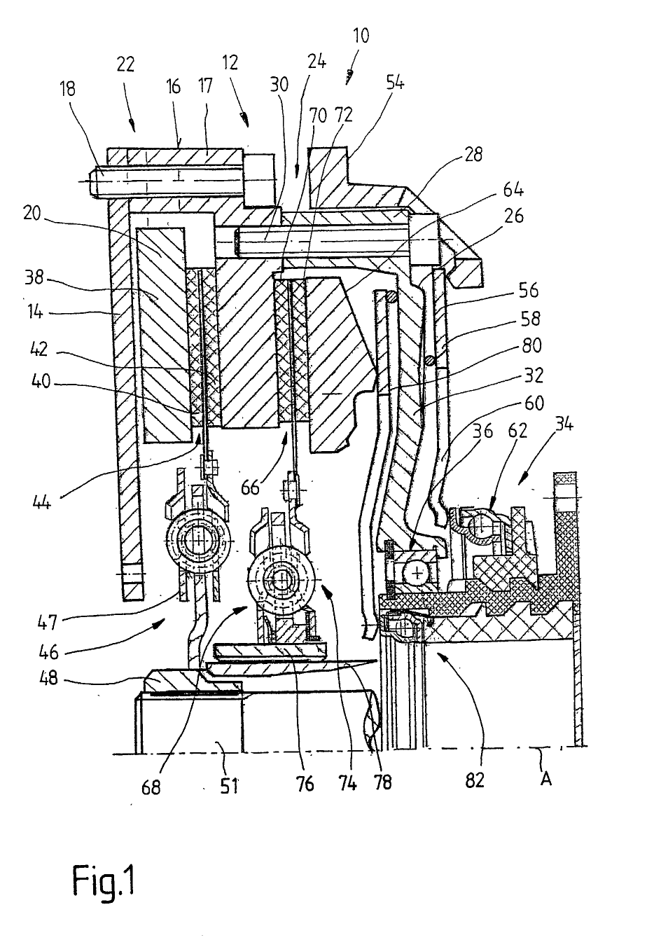

Before the various possibilities of centering the various components of a dual clutch with respect to each other to facilitate their assembly are discussed in detail, a dual clutch or the pressure plate assembly for a dual clutch will be described on the basis of FIGS. 1-3.

The dual clutch 10 or its pressure plate assembly 11 has a housing arrangement 12 overall, which consists of several parts. A disk-like part 14, which can be designed as a flywheel, as the secondary mass of a dual-mass flywheel, a driver plate, etc., has the function of connecting the dual clutch 10 to a drive shaft for rotation in common, such as a crankshaft of an internal combustion engine. A radially outer, essentially axially oriented section 17 of a housing part 16 is connected by a plurality of threaded bolts 18 to the disk-like part 14. The radially inward-extending, ring-like section 20 of the housing part 16 forms an opposing support area for the two clutch areas 22, 24 of the dual clutch 10, which will be described in greater detail below. Another housing part 26 has a radially outer, also essentially axially oriented, section 28, which is also rigidly connected by a plurality of threaded bolts 30 to the housing part 16. A radially inward-extending, ring-like section 32 of the housing part 26 provides support for the housing, i.e., support with freedom of rotation, on an actuating mechanism 34 by way of a bearing 36.

The first clutch area 22 of the dual clutch 10 comprises a pressure plate 38, which is mounted on one axial side of the opposing support area 20, which is provided on the housing arrangement 12 or which is formed by the housing arrangement. The friction surface arrangement 44 of the clutch disk 46 of the first clutch area 22 is located between this pressure plate 38 and the opposing support area 20; this friction surface arrangement comprises the friction linings 40, 42. In the exemplary embodiment shown here, the clutch disk 46 is equipped with a torsional vibration damper 47. In its radially inner area, the clutch disk 46 is designed to be connected nonrotatably by its hub 48 to a first power takeoff element, i.e., a transmission input shaft 51.

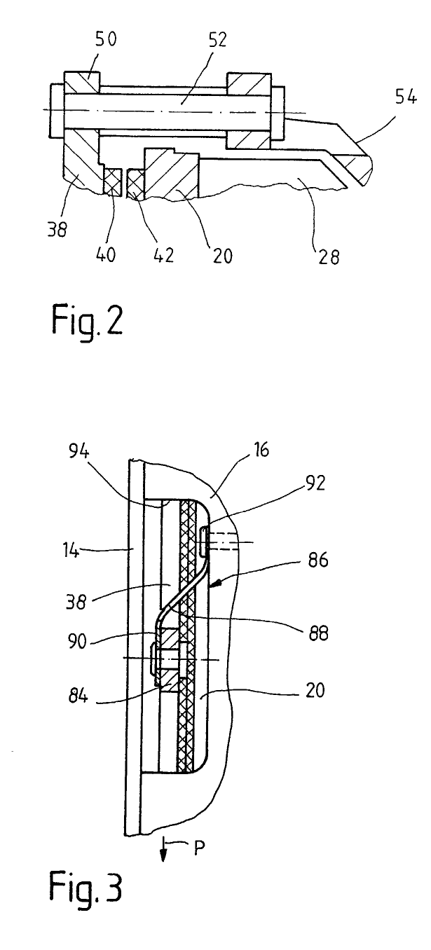

In its radially outer area, the pressure plate 38, as can be seen in FIG. 2, has radial projections 50 at several points on the circumference, which pass radially through corresponding openings in the housing part 16 with a certain amount of play in the circumferential direction. These projections 50 are rigidly connected by tension rods 52 to an actuating element 58, which can be designed in the shape of, for example, a ring. The actuating element 54 is acted upon by a radially outer area 56 of an actuating force-transmitting element 58. The radially middle area of this element is supported on the outside surface of the section 32 of the housing part 26, and its radially inner area 60 is acted upon by an actuating area 62 of the actuating mechanism 34. The actuating force-transmitting element 58 can be designed as, for example, a diaphragm spring, but it can also comprise a force-transmitting lever arrangement with several lever elements distributed around the circumference.

The second clutch area 24 has a pressure plate 64 on the other axial side of the opposing support area 20. The friction surface arrangement 66 of the clutch disk 68 of the second clutch area 24 with its friction linings 70, 72 is located between the pressure plate 64 and the opposing support area 20. In the exemplary embodiment shown, the clutch disk 68 also has a torsional vibration damper 74. In its radially inner area, the clutch disk 68 is designed to be connected nonrotatably by its hub 76 to a second transmission input shaft 78, which is essentially concentric to the first transmission input shaft 51.

An actuating force-transmitting element 80 of the second clutch area 24 is supported radially on the outside on the housing part 26, and its radially middle area acts on the pressure plate 64. Radially on the inside, the actuating force-transmitting element 80 is designed to be acted on by an actuating area 82 of the actuating mechanism 34. The actuating force-transmitting element 80 can also be designed as a diaphragm spring or as a lever arrangement.

The dual clutch arrangement 10 shown is of the normally open type. As a result of the two actuating areas 62, 82 of the actuating mechanism 34, therefore, the actuation of the various actuating force-transmitting elements 58, 80 produces an engaging force, which tries to move the pressure plates 38, 64 toward the opposing support area 20.

The connection of the pressure plates 38, 64 to the housing arrangement 12 for rotation in common is described below with reference to FIG. 3 and on the basis of the pressure plate 38 of the first clutch area 22. It is obvious that an arrangement of this type can also be provided in the second clutch area 24 and that it is advantageous to do so.

The pressure plate 38 has radial projections 84 at several points on the circumference, which can be identical to, for example, the radial projections 50 shown in FIG. 2. A connecting element arrangement 86 of the first clutch area 22 comprises a plurality of leaf spring elements 88 distributed around the circumference. One circumferential end 90 of each of these leaf spring elements is held in place by a rivet, for example, on a radial projection 84 of the pressure plate, whereas the other circumferential end 92 is attached to the housing part 16 in the area of, for example, the opening 94 through which one of the radial projections 50, 84 passes. It can be seen in FIG. 3 that the attachment to the housing part 16 is offset with respect to the attachment to the pressure plate 38 toward the opposing support area 20 in the direction of the axis of rotation A. This results in an arrangement in which the leaf spring elements 88 are curved or cranked in the section between their two ends 90, 92. By providing the leaf spring elements 88 with the appropriate deformation, it can also be ensured that these elements produce the releasing force required for the pressure plate 38, that is, a force which acts in opposition to the clutch-engaging force of the actuating area 62.

If the clutch area 22 is in a torque-transmitting state, that is, in a state in which the friction linings 40, 42 are in frictional contact with, respectively, the pressure plate 38 and the opposing support area 20, then, as a result of the transmitted torque, the pressure plate 38 is moved by the clutch disk 46 with respect to the housing arrangement 12 or the housing part 16 in the direction of the arrow P in FIG. 3. After the pressure plate 38 has been rotated a short distance relative to the housing part 16, the leaf spring elements 88 prevent any further such rotation of the pressure plate. Because of the slanted position of the leaf spring elements 88 in the area between their two ends 90, 92, however, the force acting in the circumferential direction is partially deflected, and a force which tries to move the pressure plate 38 toward the opposing support area 20 is produced. This force increases the pressure which presses the pressure plate 38 against the friction linings 40, 42, so that a self-reinforcing effect is produced as a result of the transmitted torque and the appropriate design of the leaf spring elements 88. When a dual clutch 10 with its associated clutch areas 22, 24 is designed to transmit a specific maximum clutch torque, it is therefore possible to take into account that this maximum clutch torque does not have to be produced exclusively by the force exerted by the actuating mechanism 34; on the contrary, an additional force component is supplied by the associated leaf spring elements 88. This means that the dimensions of the actuating mechanism 34 can be reduced.

In the case of a dual clutch 10 such as that described above, the basic problem is that, when the transmission is to be connected to the other components, the two transmission input shafts 51, 78 must be inserted into the associated hubs 48, 76. This process can be problematic especially when, as can also be seen in FIG. 1, at least one of the clutch areas, but usually both clutch areas 22, 24, are of the normally open type. This means that, when no force is being exerted, the clutch disks 46, 48 are not centered or held in position with respect to the housing arrangement 12 or the actuating mechanism 34. Because of the play which is basically always present in the radial direction as well, therefore, the two clutch disks 46, 68 are not centered with respect to each other. Since the two clutch disks 46, 68 are not centered with respect to the housing arrangement 12 either, they will not be in the correct position for insertion of the two transmission input shafts 51, 78.

Measures are described below which ensure that the introduction of these transmission input shafts into the hubs of the clutch disks can be accomplished more easily. It should be pointed out that these measures can be used not only in conjunction with clutches or clutch areas of the normally open type. It is obvious that these measures can also be applied in clutches or clutch areas of the normally closed type, as will also be explained in the following.

FIG. 4 shows an embodiment in which a centering element 102, forming a mounting/centering support arrangement 100, comprises a sleeve-like body area 104, made out of, for example, steel sheet or plate. Several centering tongues 106 proceed from this body area in the axial direction. Because of the elasticity of the stock used, that is, for example, because of the nature of the steel sheet or plate stock or even plastic material, these tongues can be pivoted or bent elastically. The centering tongues 106 of this centering element 102 have axial sections 110, 112 of different diameters relative to the axis of rotation A, which sections are assigned to the two hubs 48, 76, which hold the transmission input shafts. Thus the section 110, which belongs to the hub 48 with the smaller inside diameter, is a section with the smaller overall diameter, whereas the section 112, which belongs to the hub 76 with the larger inside diameter, has a correspondingly a larger diameter.

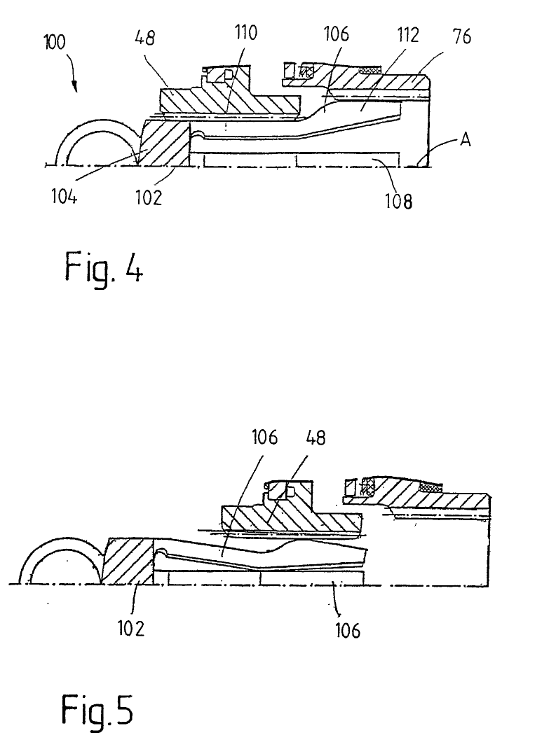

When the dual clutch 10, i.e., the pressure plate assembly 11 of the clutch, shown in FIG. 1 is being attached to the transmission or possibly even before it is attached to the transmission, therefore, the centering element 102 is pushed into the two hubs 48, 76 from, for example, the open side of the pressure plate assembly 11 to be positioned, i.e., the side facing the engine, which can occur under the elastic pivoting of the centering tongues 106. Once the state shown in FIG. 4 is reached, the two hubs 48, 76 are held in the correct position with respect to each other. This assembly can then be brought up axially toward the transmission, the two transmission input shafts 51, 78 of which are in defined radial positions with respect to each other in any case. The transmission input shaft 51 with the smaller diameter will therefore enter the hub 76 with the larger inside diameter first; it is possible to proceed here so that the insertion of this transmission input shaft 51 simultaneously pushes the centering element 102. In this case, it is preferable for the centering tongues 106 to be designed so that the centering function remains in effect until the transmission input shaft 78 with the larger diameter has also entered the associated hub 76. During this exiting movement of the centering element 102, either as a result of pushing or pulling, the centering tongues 106 are squeezed together radially toward the inside, as can be seen in FIG. 5, when the sections 112 forming the larger diameter pass through the hub 48 with the smaller diameter.

It should be pointed out that the assembly procedure could obviously be carried out by positioning the clutch so that its axis of rotation A is essentially vertical. While the centering element 102 together with the hubs 48, 76 supported on it is being held in the correct position to receive the transmission input shafts 51, 78, possibly after the position of the assembly has been adjusted by hand, the centering element 102 can then be pulled out before the clutch is set down onto the transmission assembly, positioned with its transmission input shafts 51, 78 pointing upward.

It should also be pointed out that, of course, a centering element 102 equipped with elastic tongues 106 of this type can also be introduced from the transmission side. In this case, the sections 110, 112 of different diameters would then be connected to the ring-like base body 104 in the reverse order.

As a result of the elasticity of the centering tongues 112, the tongues are pretensioned radially outward against the inside surfaces of the hubs 48, 76, so that the hubs are held in a defined position on the centering element 102 and also with respect to each other.

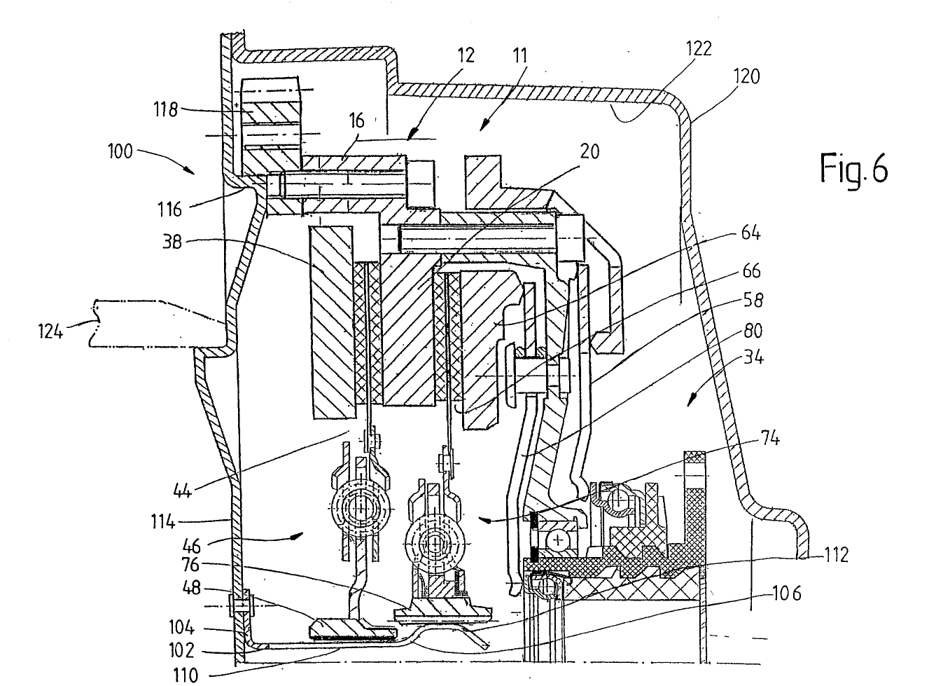

FIG. 6 shows an alternative embodiment of a mounting/centering support arrangement 100 according to the invention. It should be pointed out first that FIG. 6 shows a pressure plate assembly 11 for a dual clutch in which the two clutch areas are of the normally closed type. That is, the actuating force of the actuating mechanism 34 is transmitted to actuating force-transmitting elements 58, 80, which are designed as, for example, diaphragm springs. The clutches shown here are both of the push type. In the state in which the actuating force is not acting on them, the two pressure plates 38, 64 are pretensioned by the elastic force of the diaphragm springs 58, 80 toward the opposing support area 20 and thus clamp the friction surface arrangements 44, 66 of the two clutch disks 46, 68.

The mounting/centering support arrangement shown in FIG. 6 again comprises a centering element 102, which is basically the same in terms of design as the centering element described with reference to the preceding FIGS. 4 and 5. Here, too, the elastically deformable centering tongues 106 with their sections 110, 112 of different diameters are provided on a ring-shaped base body 104, which in this case, however, is extended radially toward the outside. The radially outward-expanded section of the centering element 102 is attached to a central area of a cover 114 associated with the pressure plate assembly 11. Radially on the outside, this cover 114 has a centering section 116, which grips an inward-facing circumferential surface of the housing arrangement 12, this surface being provided in the present case, for example, on a gear ring 118 rigidly connected to the housing part 16, and thus centers the housing arrangement 12 with respect to the two clutch disks 46, 68 carried on the centering element 102. The cover 114 can be designed as rotationally symmetric with respect to the centering section 116; that is, it can have a rim-like area extending essentially in the circumferential direction for the centering of the housing arrangement 12. Individual sections which are distributed around the circumference and which rest under elastic pretension against the inward-facing circumferential surface of the housing arrangement 12 are also possible.

In the case of the arrangement shown in FIG. 6, furthermore, a pallet 120 is preferably provided, which has a plurality of recesses 122, each of which holds a pressure plate assembly 11. In this pallet 120, i.e., in its recesses 122, the pressure plate assemblies 11 are then positioned for installation or transport, where at the same time one of the previously described covers 114 is fitted to each pressure plate assembly 11 or has already been provided thereon.

After the pallet 120 has reached the assembly station, the cover 114 can be gripped by a gripping tool 124, indicated schematically in FIG. 6, and removed from the pallet 120 together with the pressure plate assembly 11, which is held on the centering section 116 of the cover. It should be pointed out that openings could also be provided in the cover 114 to allow a tool 124 of this type to grip the pressure plate assembly 11 directly.

The pressure plate assembly 11 is then carried together with the cover 114 to a transmission, onto the transmission input shafts of which the two hubs 48, 76 are to be placed. Again it is possible to proceed by positioning the transmission with vertically oriented transmission input shafts. The cover 114 with the pressure plate assembly 11 carried on it is then oriented in a corresponding vertical position. If the pressure plate assembly 11 is now positioned in such a way that, for example, the transmission input shafts are already extending through the central opening in the actuating mechanism 34, it is then possible, if desired, to grip the pressure plate assembly with a different tool, to pull off the cover 114 in the vertical direction, to lower the pressure plate assembly 11 vertically, and to push the assembly onto the transmission input shafts until the outer teeth of the shafts engage with the internal teeth of the various hubs 48, 76. To ensure that the rotational position is correct during this procedure, it is possible, if necessary, to turn the transmission output shaft, for example, until the transmission input shafts or at least one of them has been brought into the proper relative rotational position which makes it possible for the pressure plate assembly to be pushed on.

In the case of the design shown in FIG. 6, the cover 114 has not only the function of establishing a defined correlation between the position of the clutch disks and that of the housing arrangement 12 but also, when in the transport state, the especially advantageous function of closing off the pallet which supports the pressure plate assembly 11 in question by resting on the pallet so as to create a seal. It is thus possible to eliminate almost completely any contamination or damage to the pressure plate assembly during transport. The cover 114 can also have labeling areas.

It should be pointed out that, of course, various changes can be made to the design illustrated in FIG. 6. For example, the centering section 116 can also be in the form of separate components, which are fastened to the cover 114 by screws, snap-in connections, or centering pins. Here, too, it is also obvious that steel sheet or plate stock can be used for the centering element 102 and for the cover 114 itself or that one or the other component could be made of plastic. As in the case of the embodiment described above with respect to FIGS. 4 and 5, this type of mounting/centering support arrangement 100 can also be reused, which is especially advantageous with respect to cost.

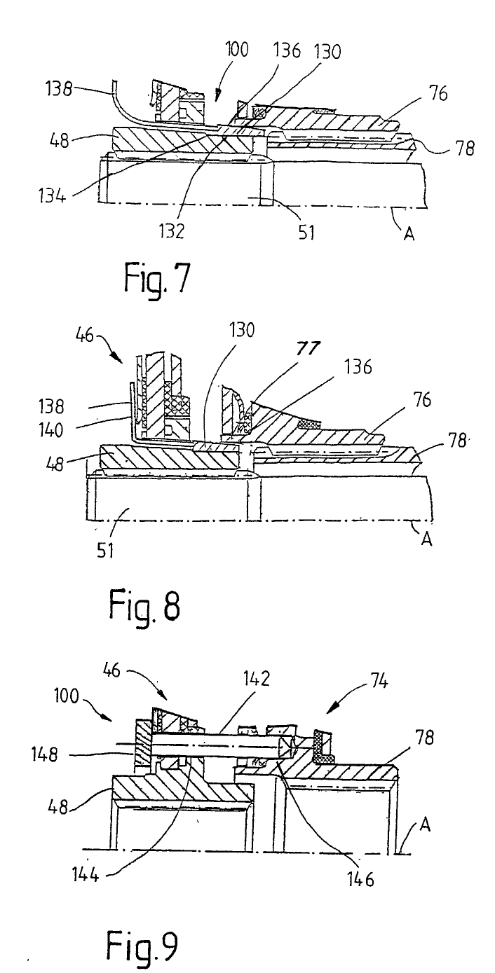

Another embodiment of a mounting/centering support arrangement 100 which facilitates the assembly work is illustrated in FIGS. 7 and 8. Here the mounting/centering support arrangement 100 comprises a preferably ring-shaped slider 130, which has a conical outside surface. The essentially cylindrical inside circumferential surface 132 of this slider 130 rests on an appropriately shaped sliding surface 134 of the hub 48. To arrive at the centered state, in which the two hubs 48, 76 are centered with respect to each other, the slider 130 is, for example, pushed axially during the assembly procedure along the surface 134 toward the hub 76, so that its wedge surface 136 rests against an extension 77 of the hub 76, which projects axially out over the hub 48. The wedge-shaped slider 130 is preferably pushed firmly into place in such a way that it cannot come loose by itself and is clamped tightly between the surface 134 of the hub 48 and the extension 77 of the hub 76.

It can also be seen in FIGS. 7 and 8 that at least one, preferably several tabs 138, which adjoin the slider in the axial direction and pass through the hub 48 or the associated clutch disk 46, are attached to the slider 130. These tabs 138 are preferably made of plastically deformable material such as steel sheet or plate stock. The function of these tabs 138 is, first, to allow a pulling action to be exerted on the slider 130 after, as shown in FIG. 7, the two transmission input shafts 51, 78 have been introduced into the hubs 48, 76 at the end of the assembly process. As a result of this pulling action, the slider 130 is pulled axially out of the position in which it clamps the two hubs 48, 76 together and is drawn closer to the hub 48, so that the wedge surface 136 of the slider 130 can no longer make contact with the hub 76 even during a clutch-release movement.

Because the slider 130 is basically a lost part, that is, a part which can no longer be removed after the introduction of the transmission input shafts 51, 78, it must be ensured that the slider 130 remains in an axial position which excludes any type of interaction between the two clutch disks or hubs with each other.

Here is where the plastically deformable tabs 138 come into play again. After the slider 130 has been moved axially out of its clamping position, these tabs are bent over radially toward the outside at a point directly adjacent to the area of the hub 48 or clutch disk 46 through which they pass, so that their free, projecting ends 140 form a section which locks the slider 130 in its inactive axial position.

Here, too, it should be pointed out that the slider 130 can also obviously be made of plastic material just as easily as it could be made of steel sheet or plate stock. The tabs 138 can also consist of various materials, although a material with the plastic deformability mentioned above is preferred. It is also possible, of course, to provide materials which can be deformed without any shape-retaining or restoring forces, in which case these sections can be bonded with an adhesive to hold the slider 130 in place.

In the case of the embodiments of the centering elements illustrated in FIGS. 4-8, they can be designed to fit together with the two clutch disks only in one or more specific relative rotational positions, which relative rotational positions correspond to a relative rotational position or to relative rotational positions of the transmission input shafts. It is thus possible in the case of the conical slider 130 shown in FIGS. 7 and 8, for example, to provide peg-and-hole arrangements acting in the circumferential direction to cooperate both with the hub 48 and with the hub 76, which arrangements, first, specify a defined relative rotational position of the slider 130 with respect to the hub 48 and, second, allow the clamping action of the slider 130 on the hub 76 to be produced, that is, allow the slider 130 to shift axially as desired, only when the hub 76 is in a defined relative rotational position with respect to the hub 48.

Another, alternative embodiment of a mounting/centering support arrangement 100 is illustrated in FIG. 9. It can be seen here that the mounting/centering support arrangement 100 comprises at least one, preferably a plurality, of centering bolts 142, which are arranged around the circumference in a circle around the axis of rotation A. These bolts pass through openings 144, 146 in the clutch disks 46, 78 or their hubs 48, 76, preferably with a comparatively tight fit to prevent the centering bolts 142 from working loose from these openings 144, 146 unintentionally as a result of vibrations. To facilitate their installation and possible removal, furthermore, the centering bolts 142 can be carried on a support ring 148. Here, too, after the transmission input shafts have been introduced into the hubs 48, 76, the centering function is released simply by removing these centering bolts 142. The radial position at which these centering bolts 142 are introduced can be selected under the criterion of maximum likelihood of excluding interaction with other components and/or the criterion of where additional openings can be tolerated without impairment to operation. It should also be pointed out that, by extending the centering bolts 142 or making them longer, they can also be fastened to an assembly rigidly connected to the housing or to a section of the housing itself. As a result, they not only center the two clutch disks 46, 68 with respect to each other but also center these two clutch disks 46, 68 with respect to the housing arrangement 12. A centering of this type would also be possible in the radial area of the friction linings, in which case a connection of the individual clutch disks to the housing arrangement 12 can be achieved simultaneously. Of course, it is also possible for the centering bolts 142 to be introduced into their centering position from the side facing the transmission. The choice can be made on the basis of which of the two assemblies, engine and transmission, are to be attached to the clutch first.

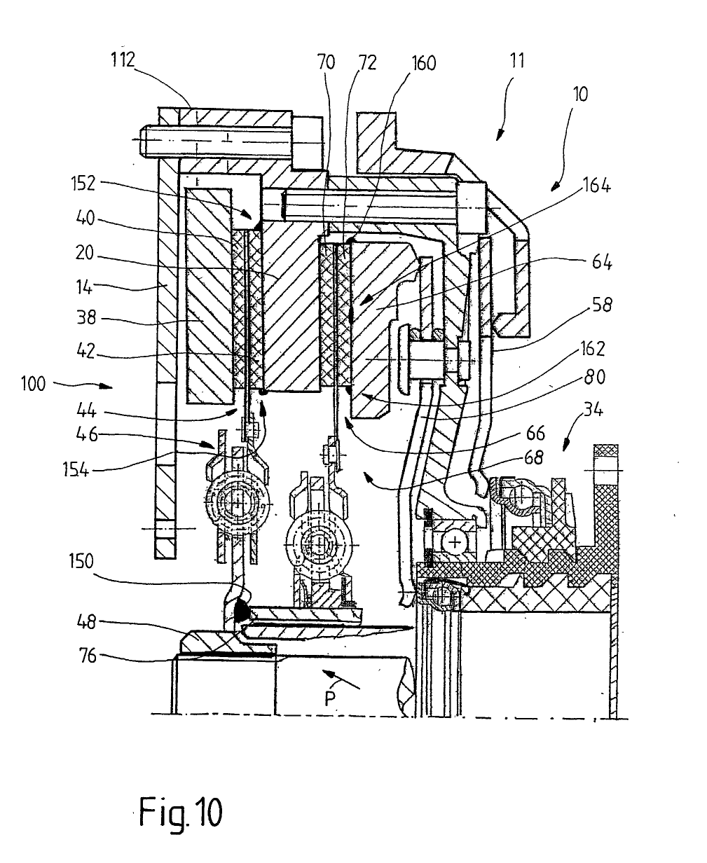

FIG. 10 shows another dual clutch 10, i.e., the pressure plate assembly 11 of such a clutch, in which a mounting/centering support arrangement 100 according to the invention is used. This comprises several bonding areas, by means of which a centering or connection of various assemblies to each other can be achieved. Thus, a bonding area 150 makes it possible for the two clutch disks 46, 68 to be bonded directly to each other. As can be seen, the hub 76 of the clutch disk 68 is bonded to a radially outward-extending flange area of the clutch disk 46. This bonding can be continuous in the circumferential direction, but it can also be accomplished by individual spots of adhesive or even by a single spot of adhesive. Access to allow the introduction of the adhesive after the pressure plate assembly has been put together can be obtained, for example, radially from the inside, at a slant, in the direction of the arrow P in FIG. 10.

Alternatively or in addition to the bonding which connects the two clutch disks 46, 68 directly to each other, it can be provided that the clutch disks are bonded radially on the outside, that is, for example, in the area of their friction surface arrangements 44, 66, to components integral to or connected to the housing such as the opposing support area 20 or the pressure plate 64. In conjunction with the clutch disk 46, it can be seen that, in the area of the friction lining 40, an adhesive bond is produced between the ring-shaped opposing support area 20 and the radially outer and radially inner areas 152, 154 of the linings. The clutch disk 68, for example, is bonded by its friction lining 72 radially on the outside at 160, radially on the inside at 162, and radially in the middle area 164 to the pressure plate 64. Of course, such bonds can also be provided in any of the areas which are comparatively close to one another. For example, the clutch disk 46 could be bonded, of course, to the pressure plate 38 or possibly directly to the housing part 14. The clutch disk 68 could be bonded directly to the opposing support area 20.

When specifying the positions of the parts by bonding them together with an adhesive, it is important that the adhesive used may not hinder the operation of the clutch afterwards. That is, it must be possible for the adhesive to be rendered ineffective by the application of a mechanical load, heat, or moisture, thus releasing the various components, originally connected tightly to each other, so that they can move freely relative to each other again. Adhesives which break down under the effect of vibration or radiation can also be used.

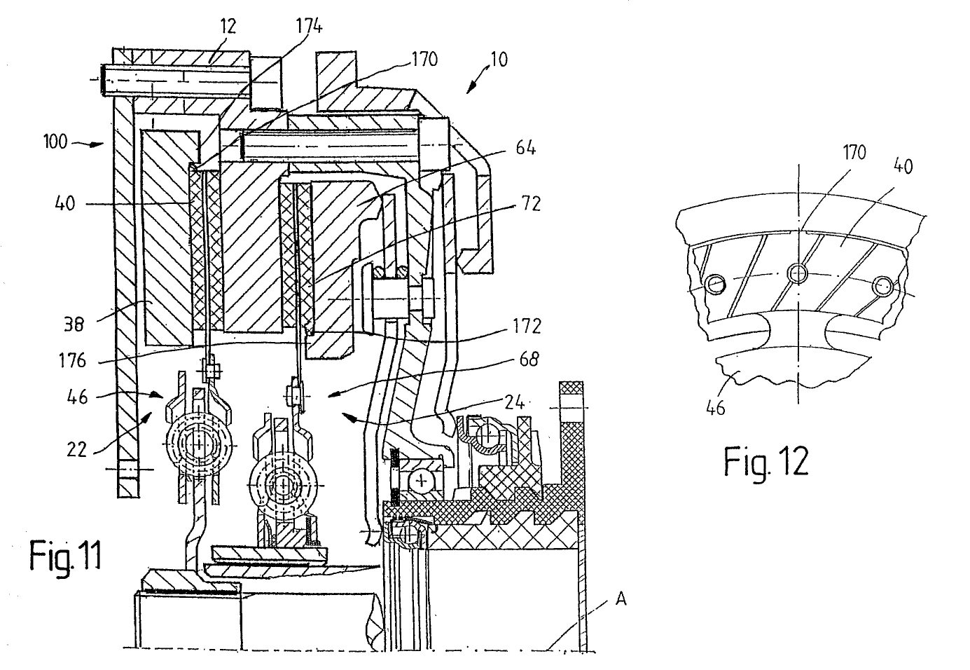

Another embodiment of a mounting/centering support arrangement is shown in FIG. 11. Here we can see radially outward-projecting centering and projections 170 radially inward-projecting centering projections 172 in the area of the friction linings 40, 72 of the two respective clutch disks 46, 68. In correlation with the radially outward-extending centering projections 170 provided on the friction lining 40, the pressure plate 38 has an axial projection 174, which radially surrounds the clutch disk 46. In the centered state, the projections 170 are in contact with this axial projection and thus hold the clutch disk 46 against the pressure plate 38 and thus against the housing arrangement 12 as well with essentially no freedom of radial movement.

In a corresponding manner, an axial, ring-shaped, circumferential projection 176 is provided on the pressure plate 64 of the second clutch area 24 to cooperate with the centering projections 172 of the friction lining 72; these centering projections 172 extend radially inward and rest against this ring-shaped projection 176. The centering projections 170, 172 also prevent or hinder in principle the freedom of rotation of the clutch disks 46, 68 with respect to the housing arrangement 12. These centering projections 170, 172 are therefore sized in such a way that, after a slight amount of relative rotation, they are either rubbed off or sheared off, which thus makes the clutch disks 46, 68 essentially free again to rotate with respect to their assigned pressure plates 38, 64.

To achieve a suitable centering function with this embodiment, it is advantageous to provide three of these centering projections 170, 172, spaced 120° apart, for example, which rest with a slight press-fit against the associated radial surfaces of the projections 174, 176. Depending on how accurate the radial fit of the transmission input shafts to be introduced is with respect to the clutch disks or hubs, it is even possible to allow a small amount of play here in the radial direction.

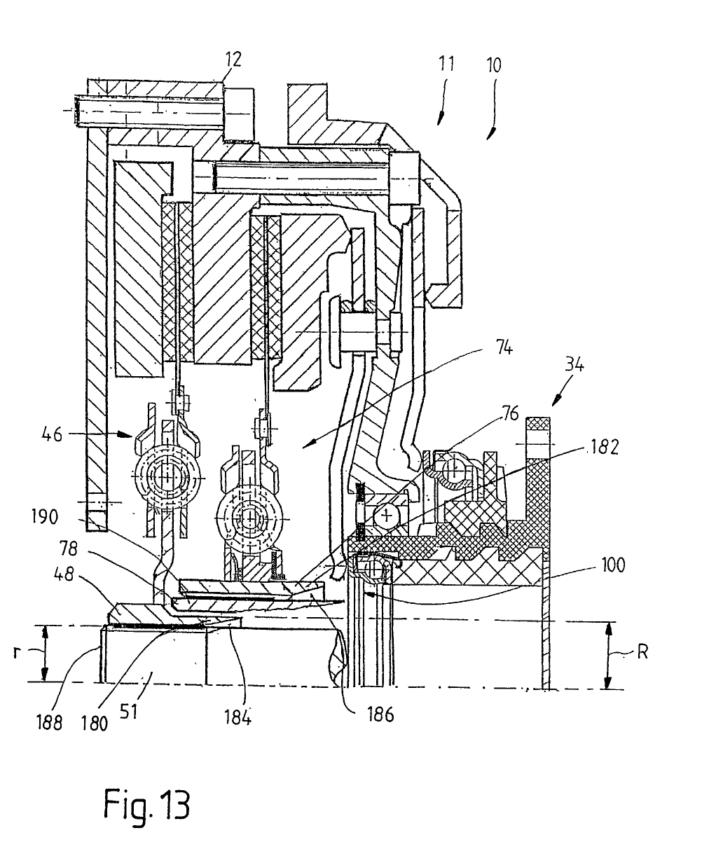

An alternative design of a mounting/centering support arrangement 100 is described below on the basis of FIGS. 13-16. In contrast to the previously described embodiments, all of which require additional elements or components, which are to be removed or inactivated after there is no longer any need for centering, the mounting/centering support arrangement 100, as can be seen in FIG. 13, is designed so that no additional components need to be provided for the purpose. Instead, this centering arrangement comprises a funnel-like insertion opening 184, 186 for at least one of the clutch disks 46, 68 or, in the example shown, for both, these openings being located at the axial ends 180, 182 of the hubs 48, 76 provided for the introduction of the transmission input shafts 51, 78. Each funnel-like insertion opening 184, 186 has the maximum distance R from the axis of rotation at the axial end, reference being made here to the hub 48 of the clutch disk 46. The same also obviously applies to the hub 76 of the clutch disk 68. This dimension R or the cross-sectional insertion area resulting from it is calculated so that, regardless of the radial positioning of the clutch disk 46, 68 in question allowed by the radial play available, this connecting cross-sectional area, defined by the radius R, completely overlaps the cross-sectional area defined by the insertion end 188 of the associated transmission input shaft, here of the transmission input shaft 51, and its maximum radius r. It is obvious that measures must be taken to ensure that the housing arrangement 12 or the pressure plate assembly 11 is brought up in a defined manner to the transmission or to the transmission input shafts 51, 78, that is, to ensure that the transmission input shafts 51, 78 are passed through the central opening of the actuating mechanism 34 in a defined position.

As a result of providing these funnel-like, expanding insertion areas, it can be ensured without the provision of additional components that, without any additional centering measures for the various clutch disks 46, 68, the clutch disks 46, 68 will necessarily be pushed into the correct position when the insertion ends 188, 190 of the transmission input shafts 51, 78 are brought up. It may be necessary in this case to turn the transmission output shaft to bring the one or other transmission input shaft into the correct rotational position for insertion into the associated hub.

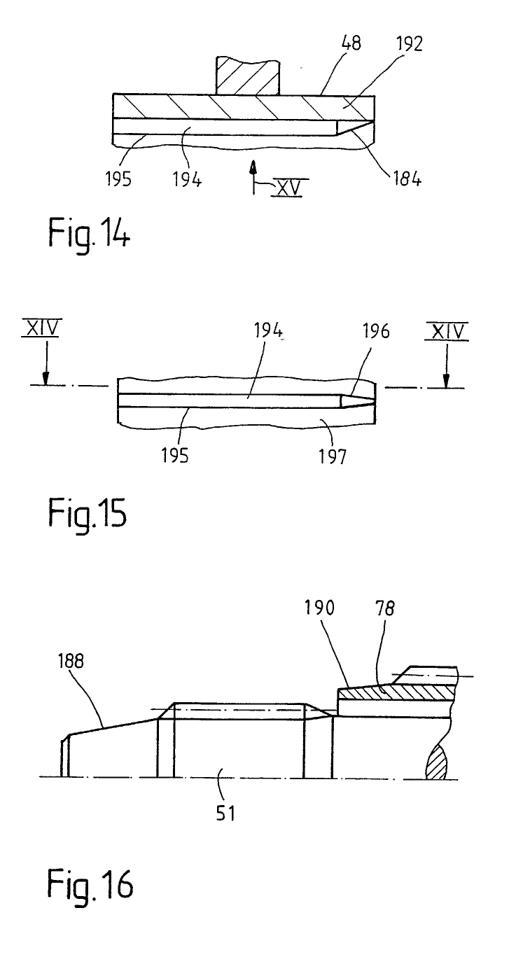

FIG. 13 shows an embodiment in which this funnel-like, expanding insertion area is provided in the body area of the hub 48, 76 itself. FIGS. 14 and 15 show that this funnel-like expanding insertion area, shown here on the basis of hub 48 as an example, does not have to be or does not have to be only on the ring-shaped circumferential body area 192 of the corresponding hub 48; on the contrary, it can also be formed on the axial ends of the teeth 194 provided on the internal circumferential surface of the body area 192. The two possibilities mentioned for the funnel-like, expanding configuration can preferably be combined and thus be present both in the body area 192 and also in the area of the teeth 194.

As can be seen in FIG. 15, the toothing 194 or the individual teeth 195 can be designed so that they have end sections 196 which also taper in the circumferential direction at the axial end provided for insertion. Here, therefore, there is simultaneously the possibility of correcting for an inaccuracy in the relative rotational position between the hub and the transmission input shaft.

It should be pointed out that the tapering configurations provided in the area of the teeth can be provided on all of the teeth arranged around the circumference, the lengthwise dimension of which proceeds in the axial direction, or it can be limited to individual teeth which have their lengthwise dimension extending in the axial direction.

In addition, the introduction of the transmission input shafts 51, 78 can be facilitated by providing their insertion ends 188, 190 with a taper, as shown in FIG. 16.

Another possibility applicable to clutches or dual clutches with clutch areas of the normally open type for precentering the various clutch disks to facilitate the assembly work, especially the attachment to the transmission, consists in ensuring that, either by means of the actuating mechanism already present or by means of temporary elements provided for the purpose, the clutch disks are first centered at the factory and then held in a defined manner with respect to the housing arrangement 12 by the pressure of the pressure plates. Here, for example, clamping elements, which hold the respective actuating force-transmitting elements 58, 80 under pretension with respect to the housing arrangement 12, can be provided, which can then be removed after the attachment to the transmission. Here, therefore, an actuating force simply for the sake of installation is produced, which also allows the process of attaching the clutch to the transmission to be performed more easily. Other types of sealing elements such as an adhesive or the like can also be used here.

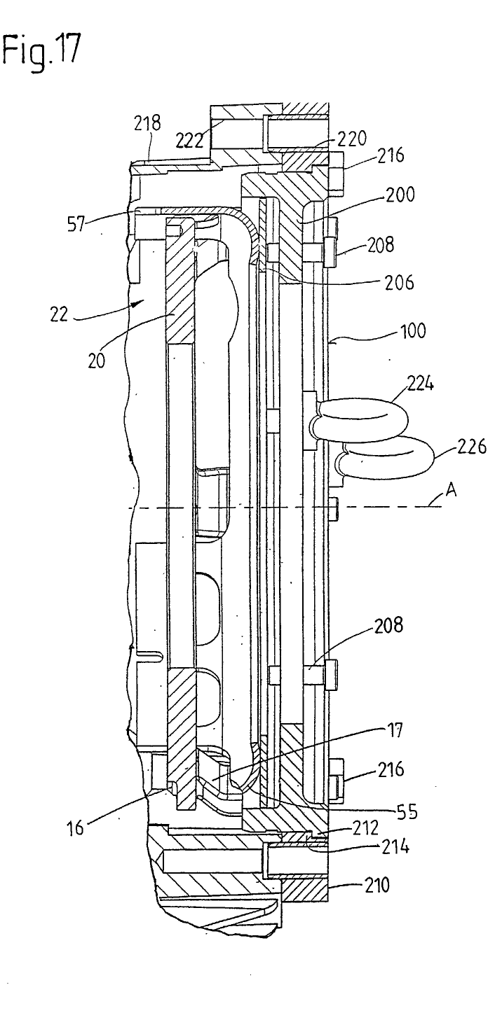

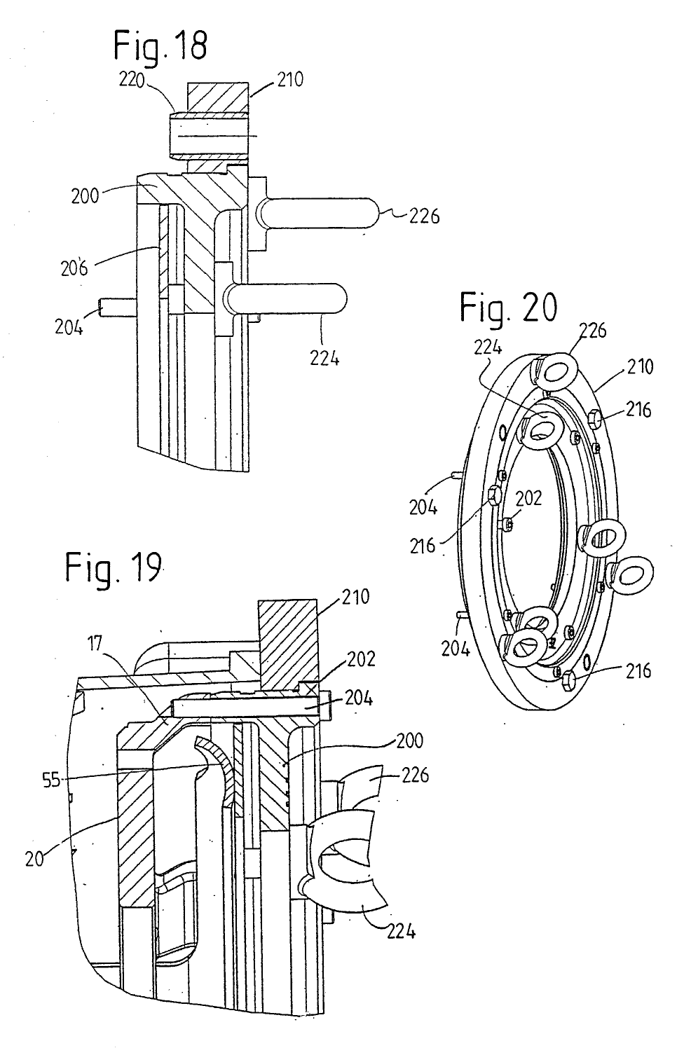

An embodiment of a mounting/centering support arrangement is described below with reference to FIGS. 17-20, which can be used to produce this type of for-the-sake-of-installation actuating force. It should be explained at the outset that, in FIG. 17, only the parts of the clutch area 22 of the dual clutch 10 which are close to the engine and relevant to the following explanation are shown. These parts consist of, first, the ring-shaped section 20 of the component designated as the housing part 16 in FIG. 1, which provides essentially an opposing support area, and which is to be connected by way of several axially oriented sections 17 to the drive unit. The second relevant part is an actuating element 55, which can be connected rigidly to the actuating element 54 shown in FIG. 1 to span the ring-shaped area 20 in the axial direction. For this purpose, for example, the actuating element 55 can have several axial projections 57, which pass through associated openings in the housing part 16 and are then connected rigidly to the actuating element 54. The actuating element 55 extends over the pressure plate 38 of the second clutch area 22 on the side facing away from the ring-shaped area 20 and thus transmits an actuating force to it.

The arrangement shown in FIGS. 17-20 comprises three essential components. A first, ring-shaped mounting element 200 has, as can be seen in FIG. 19, pass-through openings 202 at several points on the circumference, through which threaded bolts 204 pass, which can be screwed into the axial projections 17 of the component 16. In this way, a rigid connection of this first mounting element 200 to the component 16, serving as the opposing support, can be achieved. A second mounting element 206, designed as a washer, is provided inside the ring-like first mounting element 200. This second mounting element can be shifted in the direction parallel to the axis of rotation A and is supported axially by several threaded bolts 208, carried in internally threaded openings in the first mounting element 200. After the first mounting element 200 has been attached to the component 16, the threaded bolts 208 can be turned to bring the mounting element 206 in contact with the actuating element 55 to press it toward the ring-like area 20. Via the pressure plate 38 visible in FIG. 1, it is also possible to arrest the associated clutch disk 46 with respect to component 16 and thus with respect to the entire pressure plate assembly.

A third ring-like mounting element 210 is rigidly connected in the axial direction to the first mounting element 200 via radial shoulder areas 212, 214. On the other axial side, several threaded bolts 216 carried on the third mounting element 210 grip the first mounting element 200 so that these two mounting elements 200, 210 form an assembly which is held firmly together in the axial direction. Before the threaded bolts 216 are tightened, it is possible in principle for the third mounting element 210 to be rotated with respect to the first mounting element 200 and thus also with respect to the second mounting element 206. To cooperate with a transmission shroud, designated 218 overall, into which the pressure plate assembly is to be integrated, the third mounting element 210 has centering elements 220. These can be inserted into associated holes 222 in the transmission shroud 218; when the transmission, which is already attached to the pressure plate assembly, is to be installed, threaded bolts can be passed through these holes 222 to establish the connection with the engine block. It would also be possible to use continuous threaded bolts to attach the third mounting element 210 in place of the elements 220.

It can also be derived from the figures that mounting lugs 224, 226 are also provided both on the first mounting element 200 and on the third mounting element 210. These lugs make it easier to handle the assembly.

When the arrangement shown in FIGS. 17-20 is used, the first ring-like mounting element 200 will first be attached to the pressure plate assembly or to the component 16 of that assembly. Then, possibly after the clutch disk 46 of the clutch area 22 has been positioned suitably, the screws 208 can be tightened to press the second mounting element 206 toward the actuating element 55 and thus to press the pressure plate 38 under the intermediate presence of the clutch disk 46 toward the ring-like area 20. In this way, the clutch disk 46 of the clutch area 22 is first held in place in a defined manner. Then, possibly after further adjustment to the rotational position of the clutch disk of the other clutch areas 24, the entire arrangement can be introduced into the transmission shroud 218, which can be positioned so that it faces vertically upward, for example, where, through insertion of the centering elements 220 into the associated openings 222, a defined rotational position is specified for the third mounting element 210. During this process of axial insertion, the previously described transmission input shafts are simultaneously introduced into the associated hub areas of the clutch disks. Thereafter, by rotating the first mounting element 200 with respect to the third mounting element 210, the rotational position of the pressure plate assembly in the transmission shroud 218 can be specified. The reason that this is important is that, during the axial approach of the unit comprising the transmission and the pressure plate assembly to the engine, it is necessary, first, for the holes 222 shown in FIG. 17 to be aligned with the holes provided for the purpose in the engine block; second, it is necessary for the holes provided in the axial projections 17 to be aligned with associated holes in, for example, a flexplate or some other element, as shown in FIG. 1, by means of which the connection to a power takeoff shaft is to be accomplished. A screwed connection can be produced in this area through holes provided appropriately in the transmission shroud or clutch shroud.

It can be concluded from the preceding description that, as a result of the arrangement shown in FIGS. 17-20, the pressure plate assembly and the transmission can be attached to each other to form a unit, brought into a predetermined installation position for attachment to the drive assembly, and then transported to a different location in this defined position. Before attachment to the drive unit, however, the arrangement must be loosened at least by loosening the threaded bolts 204 and then removed axially to make it possible for the drive unit to be brought into position.

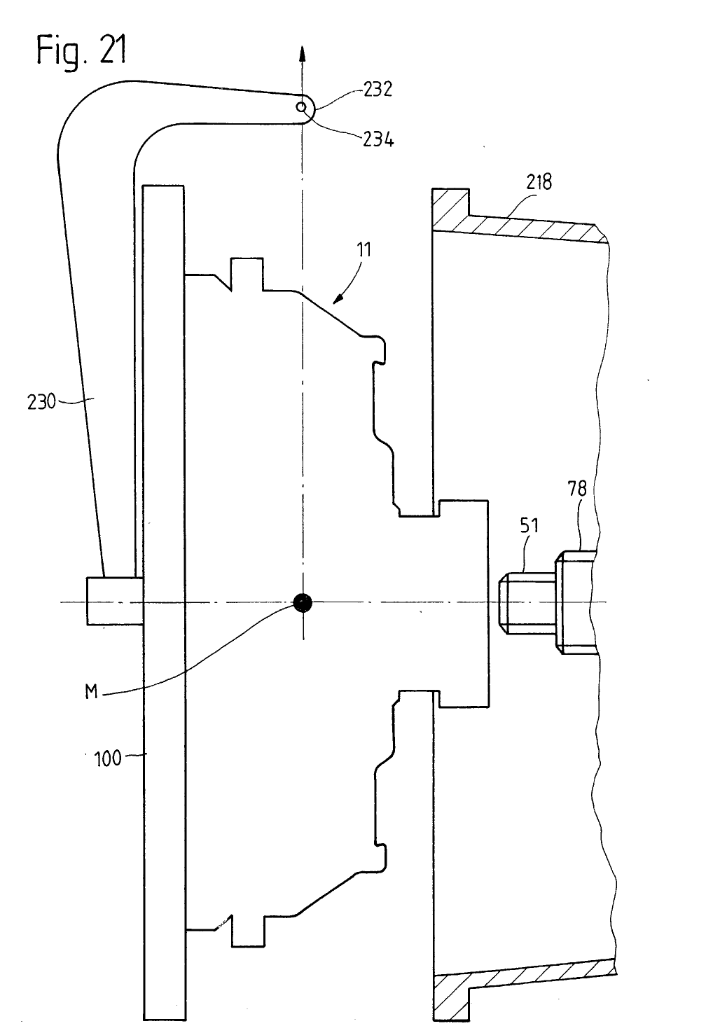

FIG. 21 shows an arrangement by means of which a pressure plate assembly 11, shown here schematically, can be mounted in a horizontally mounted transmission, that is, in a transmission whose axis of rotation is being held essentially in a horizontal position. The transmission shroud 218 and the transmission input shafts 51, 78 inside it can be seen again. An angle-shaped hanger 230 can be provided on the mounting/centering support arrangement 100 shown in FIGS. 17-20, but also on one of the previously described arrangements such as that shown in FIG. 6; one end of this angled hanger is attached to the arrangement 100, such as to a central area thereof, and the other end 232 projects axially over the pressure plate assembly 11, so that a hanging hole 234 can be situated axially approximately over the center of gravity M of the assembly formed by the arrangement 100 and the pressure plate assembly 11. As a result, the pressure plate assembly 11 can be suspended with the orientation shown in FIG. 21, in which, by axial approach to the transmission or to the transmission shroud 218, the transmission input shafts 51, 78 can be introduced into the pressure plate assembly, i.e., into the clutch disks present therein. The free end 232 of the hanger 230 extends axially over the transmission shroud 218, so that there will not be any mutual interference. It is also possible, of course, especially in the case of the embodiment shown in FIGS. 17-20, to carry out the assembly work in such a way that the transmission shroud 218 is positioned with its opening facing upward, so that the pressure plate assembly, which is carried by the arrangement 100 in the area of the mounting lugs 226, 224, can then be brought into position from above.

As already explained, all of the design variants according to the invention can be used both in clutches or dual clutches of the normally open type and also in those of the normally closed type, where the problem arising from the lack of centering occurs especially in cases of clutches of the normally open type or in the case of dual clutches which have at least one such clutch area. In the case of multi-clutch arrangements which have several clutch areas of the normally open type, it can be advantageous even to hold only one of the clutch disks in a defined position with respect to the housing arrangement and, for attachment to another assembly such as to a transmission, to ensure by appropriate maneuvering that the other clutch disk or the other clutch disks arrive in the correct position also.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A pressure plate assembly of a multi-clutch arrangement, said pressure plate assembly comprising
a housing,
a pair of pressure plates connected to said housing for rotation in common about an axis of rotation and which can be shifted axially with respect to said housing,
an opposing support arranged between said pressure plates,
a pair of clutch disks having friction surfaces which can clamped between said opposing support and respective said pressure plates, each said clutch disk being connectable nonrotatably to a respective power takeoff element, and
a support arrangement comprising means for arresting one of said clutch disks in a predetermined position with respect to at least one of said housing and the other said clutch disk.

2. A pressure plate assembly as in claim 1 wherein said support arrangement comprises a centering element arrangement which cooperates with said clutch disks to center the clutch disks with respect to each other.

3. A pressure plate assembly as in claim 2 wherein each said clutch disk comprises a hub having an inside circumferential surface, said mounting and centering support arrangement comprising a plurality of centering tongues which contact the inside circumferential surfaces of said hubs.

4. A pressure plate assembly as in claim 3 wherein said centering tongues rest under pretension against the inside circumferential surface of at least one of said hubs.

5. A pressure plate assembly as in claim 2 wherein each said clutch disk comprises a hub having an inside circumferential surface and an outside circumferential surface, said centering element arrangement comprising at least one wedge-shaped slider element which can be clamped between the inside circumferential surface of one of said hubs and the outside circumferential surface of the other of said hubs.

6. A pressure plate assembly as in claim 5 wherein said at least one wedge-shaped slider element comprises at least one fastening element which can be acted upon to release the clamping and which can be deformed to hold the at least one wedge-shaped slider element on one of the clutch disks in a position in which the slider element does not center the two clutch disks with respect to each other.

7. A pressure plate assembly as in claim 2 wherein said centering element arrangement comprises at least one centering bolt which engages the clutch disks when centering is established and which can be axially shifted in the direction of the axis of rotation to release the centering.

8. A pressure plate assembly as in claim 2 wherein the centering of the clutch disks can be released by the axial displacement of the centering arrangement with respect to the clutch disks.

9. A pressure plate assembly as in claim 2 wherein said centering element arrangement comprises a rotational position indicator which cooperates with complementary rotational position indicators on the clutch disks to indicate the relative rotational position of the clutch disks with respect to each other.

10. A pressure plate assembly as in claim 2 wherein each said clutch disk comprises a hub, and wherein said centering element arrangement comprises a breakable adhesive bond between said hubs.

11. A pressure plate assembly as in claim 10 wherein said adhesive bond can be broken by applying one of a mechanical load, heat, and moisture.

12. A pressure plate assembly as in claim 1 comprising a centering element arrangement which cooperates between at least one of the clutch disks and at least one of the respective pressure plate, the opposing support, and the housing.

13. A pressure plate assembly as in claim 12 wherein said centering element arrangement comprises adhesive bonding.

14. A pressure plate assembly as in claim 13 wherein said adhesive bond can be broken by one of a mechanical load, heat, and moisture.

15. A pressure plate assembly as in claim 12 wherein said centering element arrangement comprises a plurality of centering projections arranged on the friction surface of at least one of the clutch disks, said projections making contact with a centering area on at least one of the respective pressure plate, the opposing support, and the housing.

16. A pressure plate assembly as in claim 15 wherein said centering projections are at least partially removed when the clutch disk rotates with respect to the centering area.

17. A pressure plate assembly of a multi-clutch arrangement, said pressure plate assembly comprising
a housing,
a pair of pressure plates connected to said housing for rotation in common about an axis of rotation and which can be shifted axially with respect to said housing,
an opposing support arranged between said pressure plates,
a pair of clutch disks having friction surfaces which can clamped between said opposing support and respective said pressure plates, each said clutch disk having a hub and being connectable nonrotatably to a respective power takeoff element, and
a funnel-like insertion arrangement on at least one of said hubs for receiving the respective power takeoff element.

18. A pressure plate assembly as in claim 17 wherein at least one of the clutch disks is held with radial play with respect to the housing and has an insertion opening in said insertion arrangement which is sufficiently large to overlap essentially the entire end of the takeoff element regardless of the radial position of the clutch disk relative to the housing.

19. A pressure plate assembly as in claim 17 wherein each said hub has an inside circumferential surface with axially extending teeth for rotationally connecting to a respective power takeoff element, at least part of said insertion arrangement being provided on at least one of said teeth.

20. A pressure plate assembly as in claim 17 wherein each said hub has an inside circumferential surface with axially extending teeth for rotationally connecting to a respective power takeoff element, at least one of said teeth being tapered toward an insertion opening.

21. A pressure plate assembly of a multi-clutch arrangement, said pressure plate assembly comprising
a housing,
a pair of pressure plates connected to said housing for rotation in common about an axis of rotation and which can be shifted axially with respect to said housing,
an opposing support arranged between said pressure plates,
a pair of clutch disks having friction surfaces which can clamped between said opposing support and respective said pressure plates, at least one of said clutch disks being held with radial play with respect to the housing,
each said clutch disk having a hub with an insertion opening and being connectable nonrotatably to a respective power takeoff element, said insertion opening being sufficiently large to overlap essentially the entire end of the takeoff element regardless of the radial position of the clutch disk relative to the housing.

22. A pressure plate assembly of a multi-clutch arrangement, said pressure plate assembly comprising
a housing,
a pair of clutch areas, each clutch area comprising a pressure plate connected to said housing for rotation in common about an axis of rotation and which can be shifted axially with respect to said housing, an opposing support arranged between said pressure plates, and a clutch disk having friction surfaces which can clamped between said opposing support and the respective said pressure plate, each said clutch disk being connectable nonrotatably to a respective power takeoff element, at least one of said clutch areas being in a released state when no actuating force is acting and which can be brought into the engaged state by an actuating force, and
means for introducing an installation actuating force in said at least one of said clutch areas during assembly to the respective power takeoff element, whereby the clutch disk of said at least one clutch area is clamped between the respective said pressure plate and the opposing support.

23. A pressure plate assembly as in claim 22 wherein said means for introducing an installation actuating force comprises
a first mounting element which can be connected to the opposing support, and
a second mounting element which can be shifted axially with respect to the first mounting element to produce said installation actuating force.

24. A pressure plate assembly as in claim 23 further comprising a third mounting element which can be attached to a transmission shroud, said first mounting element being carried on said third mounting element so that the rotational position of the first mounting element can be adjusted.
